(19) United States
(12) Patent Application Publication
(10) Pub. No.: US 2013/0212399 A1
(43) Pub. Date: Aug. 15, 2013

(54) Travel Vault

(71) Applicant: Geoffrey I. Cairns, Redmond, WA (US)

(72) Inventor: Geoffrey I. Cairns, Redmond, WA (US)

(21) Appl. No.: 13/587,853

(22) Filed: Aug. 16, 2012

Related U.S. Application Data
(60) Provisional application No. 61/524,325, filed on Aug. 17, 2011.
(60) Provisional application No. 61/525,187, filed on Aug. 19, 2011.

(51) Int. Cl. G06F 21/60

(52) U.S. Cl. CPC G06F 21/60
USPC 713/182

(57) ABSTRACT

A travel vault includes a system and method for backing up and retrieving an encrypted data file containing user identification and credential information held in the dedicated tamperproof module of a mobile device. During backup, the encrypted data file is locked by the user with a personal identification number (PIN) and stored on a server secured by an HSM (Hardware Security Module). The user may then later retrieve and re-provision the locked, encrypted data file containing the user's identification and credentials into another dedicated tamperproof mobile device, provided the user verifies his identity by providing the PIN used to lock the file, and/or verifies his identity through an out-of-band user authentication process.

### PRIORITY CLAIMS

This application claims priority from Provisional Application No. 61/524,325 filed on Aug. 17, 2011, which is incorporated herein by reference in its entirety.

This application claims priority from Provisional Application No. 61/525,187 filed on Aug. 19, 2011, which is incorporated herein by reference in its entirety.

### FIELD OF INVENTION

System and Method for remotely and securely backing up and restoring a user's identity and security credentials resident on a dedicated tamperproof mobile device that is used for such things as accessing accounts, logging into websites, signing on to systems and devices, making payments, opening locks, and the like.

### BACKGROUND

### Cross-References to Related Applications

PCT US 2011/064173 Hand-held Self-Provisioned PIN PED Communicator As mobile commerce adoption continues, mobile network devices such as Smartphones or iPhones and their associated e-wallet applications will include more user-specific payment options. For example, users will include their payment information from credit cards such as American Express, Visa, or MasterCard; loyalty cards; or pre-paid debit cards.

These mobile devices will increasingly include non-payment identity and security credentials used for such things as accessing accounts, logging into websites, signing on to systems, and gaining access to physical assets, for example for opening a locked automobile door.

In addition to these mobile network devices, other secure portable devices are emerging that will be used, either stand alone or connected to an e-wallet application on a network device, to store identity and security credential information for the payment and access functions described above. These devices will have the characteristics of being secure, tamperproof, and able to function independent of access to the network.

An example of such a device is the Padloc, from NFC Data, Inc. Padloc is a hand-held mobile device that contains a dedicated tamperproof module used for storing and securely transmitting user identity and credential information.

Whether the user maintains identity and credentialing information in software on the network device, or in a separate tamperproof module in a mobile device, users will want to remotely and securely back-up their identity and security credentials. For example, if the user's device is damaged or lost, the user, and only the user, will need to be able to obtain a replacement device and to securely re-provision the user's identity and credentials onto the new device. This involves storing the identity and credential information in an encrypted data file, locking it by the user with a PIN (personal identification number), storing the locked, encrypted file in a remote, secure place such as a data center kept within a Hardware Security Module (HSM) infrastructure, and later restoring the user's identity and credentials to the device once the user provides a PIN and is verified through the use of out-of-band authentication.

US Patent Application 2010/0241848 A1 (Smith et. al.) System and Method for Securely Communicating with Electronic Meters (Search: HSM Security Device Management)

U.S. Pat. No. 6,747,547 B2 Jun. 8, 2004 (Benson) Communication Method and Apparatus Improvements

U.S. Pat. No. 6,934,858 B2 Aug. 23, 2006 (Woodhill) System and Method of Using the Public Switched Telephone Network in Providing Authentication or Authorization

U.S. Pat. No. 7,574,733 B2 Aug. 22, 2009 (Woodhill) System and Method of Using the Public Switched Telephone Network in Providing Authentication or Authorization

Tamper Resistant Devices, also known as Tamper Proof Devices, are described in more detail in http://www.sevecom.org/Presentations/2006-06_Paris/Sevecom_{—}2006-06-26_A%20Tamper%20Proof%20Devices%20-%20bute.PDF and is incorporated herein its entirety by reference.

Google Wallet offers a system to store user identity and credentials that allow users to pay using their credit cards including VISA, MasterCard, American Express or the like. Google Wallet stores credential information in an application, and backs up that information on secure Google servers http://www.zdnet.com/google-wallet-goes-cloud-based-to-support-all-major-credit-debit-cards-7000001988/

ISIS http://www.paywithisis.com/, provides similar functionality by consolidating payment credentials onto a phone, and the ability to back up user credentials.

The ability to securely store and retrieve credentialing information is distinguished from the prior art in that Travel Vault uses an HSM to store the credentials, and uses a Distributed Registration and Access Control System to manage the storage and retrieval of the secured credentials in conjunction with out-of-band authentication.

Therefore, there is a need for Travel Vault that is not being met in the marketplace today.

This and all other referenced patents and applications are incorporated herein by reference in their entirety. Furthermore, where a definition or use of a term in a reference, which is incorporated by reference herein is inconsistent or contrary to the definition of that term provided herein, the definition of that term provided herein applies and the definition of that term in the reference does not apply.

### SUMMARY OF THE INVENTION

A system and method for backing up and retrieving an encrypted data file containing user identification and credential information held in the dedicated tamperproof module of a mobile device. During backup, the encrypted data file is locked by the user with a personal identification number (PIN) and stored on a server secured by an HSM (Hardware Security Module). The user may then later retrieve and re-provision the locked, encrypted data file containing the user's identification and credentials into another dedicated tamperproof mobile device, provided the user verifies his identity by providing the PIN used to lock the file, and/or verifies his identity through an out-of-band user authentication process.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a diagram of interaction between the tamperproof module within the user's mobile device and the secure backup system for storing the user's locked, encrypted identity and security credentials.

FIG. 2 is a diagram of interaction between the tamperproof module within the user's mobile device and the secure backup system for retrieving and re-provisioning the user's identity and security credentials.

FIG. 3 describes a process by which a user provisions a secure mobile device with payment and credential information from the user's card (e.g. a Visa payment card) to create identification and credential data, enters the data into the dedicated tamperproof mobile device, uses a PIN to lock the data, and sends the locked, encrypted data to the remote storage secured with a Hardware Security Module (HSM), where the data can be subsequently re-provisioned to the secure device.

### DETAILED DESCRIPTION

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

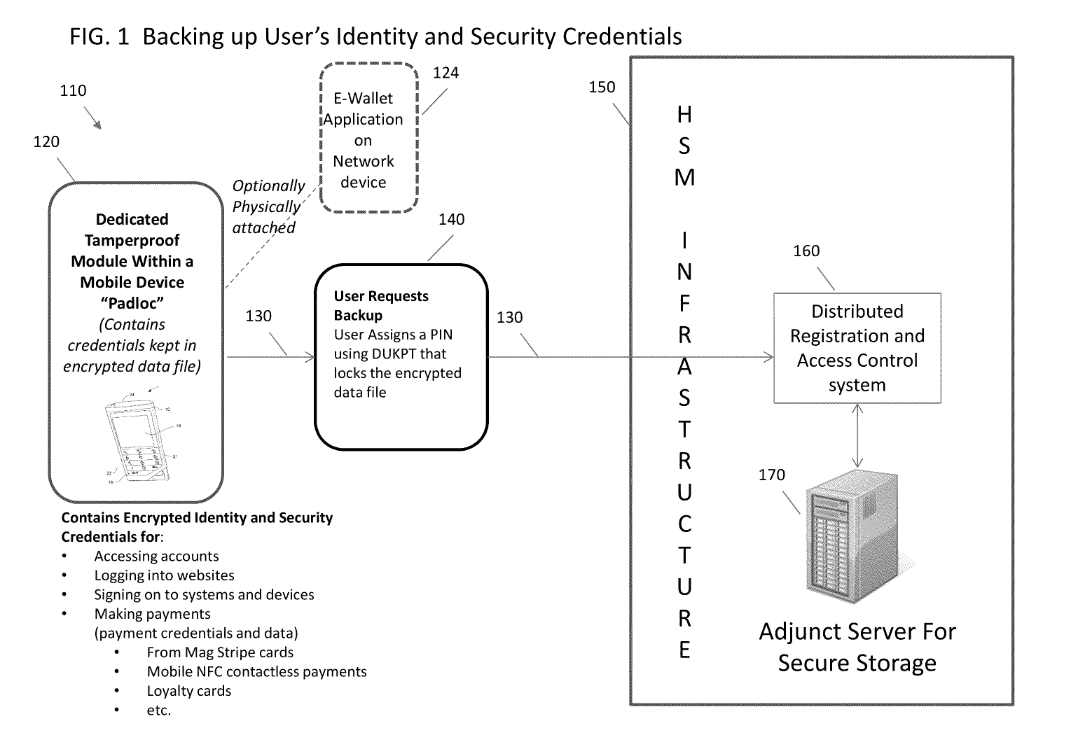

FIG. 1 illustrates a system (110) for remotely and securely storing a back-up of a user's identity and/or security credentials (multiple, with no limit) that are resident on a dedicated tamperproof module within a mobile device (120) that runs either standalone or in-conjunction with and physically attaches to an e-wallet application on a network device (124). The identity and security credentials that are being backed up from the device are used for such things as accessing accounts, logging into websites, signing on to systems and devices, making payments and the like. Payments credentials and data include, but are not limited to, mag stripe cards, mobile NFC contactless payments, or loyalty cards.

The identity and security credentials are sent via network (130) in an encrypted form directly from the tamperproof device. As part of the back-up process (140) the user assigns a PIN that locks the encrypted file using DUKPT. The user must use that PIN in the retrieval/re-provisioning process.

The tamperproof device sends the encrypted data (130) and resolves storage (160) using a network and Hardware Security Module (HSM) infrastructure. (150)

A Distributed Registration and Access Control System (160) manages the secure storage space that is assigned to a user for the purpose of storing a back-up copy of their digital identity and security credentials. The assigned storage is available securely via the network on 24/7/365 basis. The Distributed Registration and Access Control System (160) also monitors and cuts off access to the secure back-up when a small number of failed restoration attempts are made with an invalid user PIN.

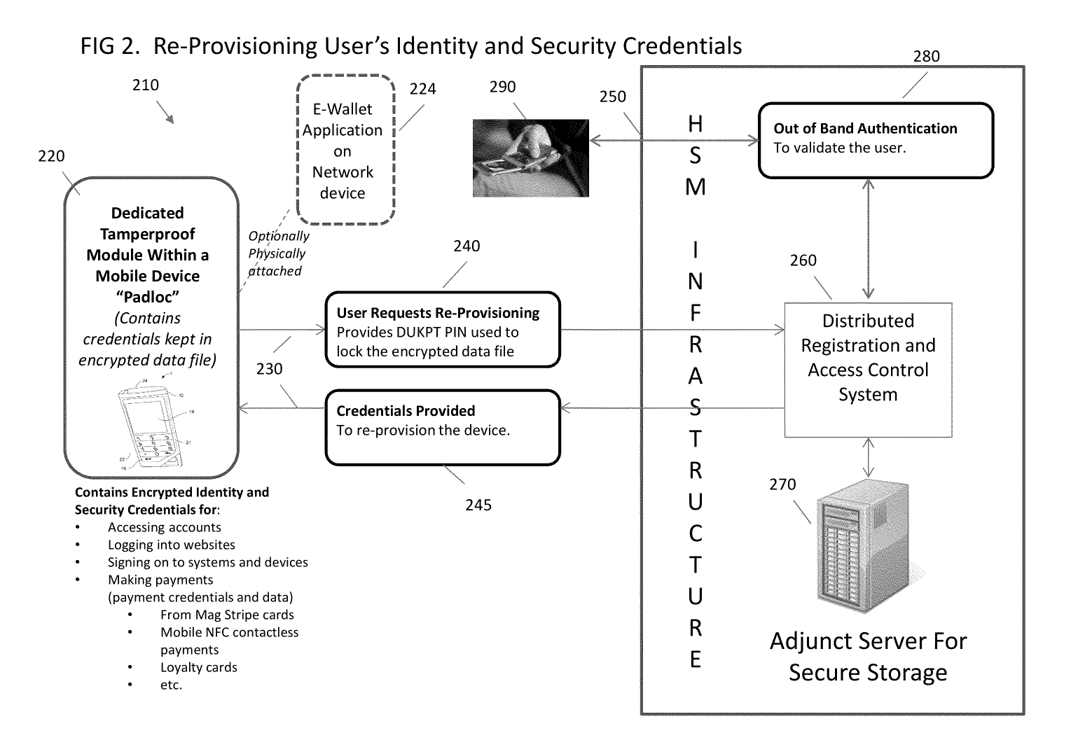

FIG. 2. Illustrates a system (210) for re-provisioning the user's identity and/or security credentials onto a dedicated tamperproof module within a mobile device (220) or e-wallet application working in conjunction with a tamperproof module (224).

The user requests re-provisioning and provides the DUKPT PIN the user assigned during the backup process (240). The re-provisioning request goes via the Internet to a Distributed Registration and Access Control System (260) that manages the secure storage space that is assigned to a user for the purpose of storing a back-up copy of their digital identity and security credentials. The Distributed Registration and Access Control System also monitors and cuts off access to the secure back-up when a small number of failed restoration attempts are made with an invalid user PIN. The assigned storage is available securely via the Internet on 24/7/365 basis and is stored behind the security of a Hardware Security Module (HSM) infrastructure (250).

As part of the re-provisioning request, an out of band authentication and a network connection may be used to verify the user making the re-provisioning request. (280) If the authentication is successful and the PIN matches, the Distributed Registration and Access Control System (260) provides the appropriate credentials via the internet (245) to the Tamperproof Mobile Device (220).

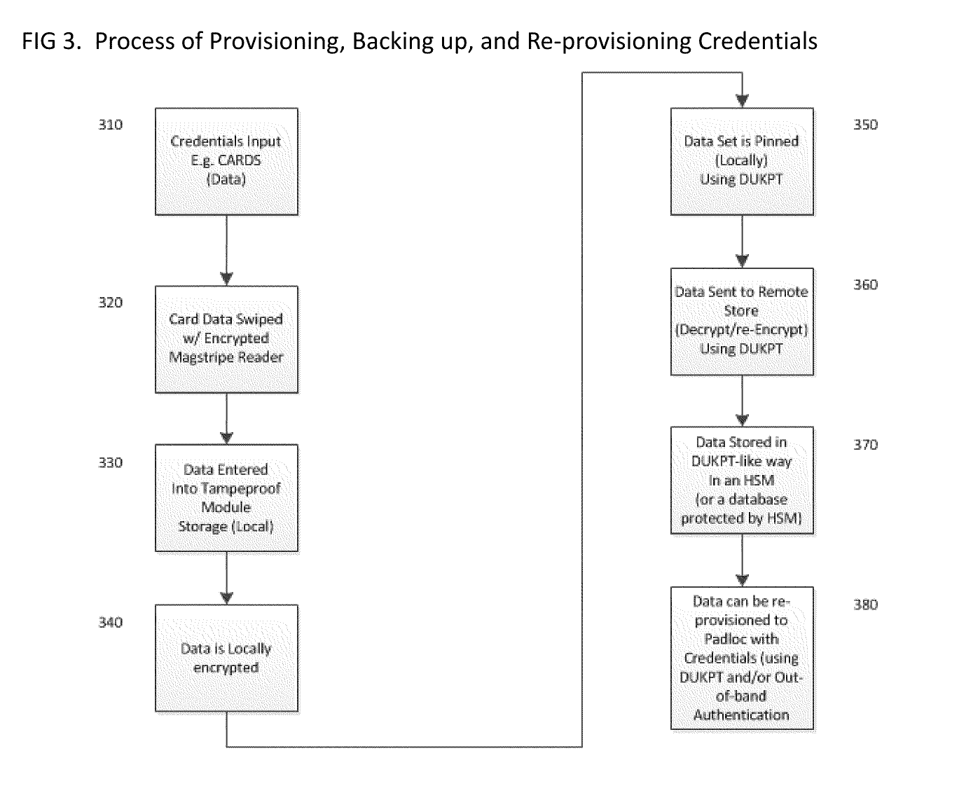

FIG. 3. Illustrates the process of provisioning, backing up, and re-provisioning the user's identity and/or security credentials on the tamperproof mobile device. A user takes credential data, such as consumer credit-card payment data (310) and captures that information via an encrypted magstripe reader (320) to be entered into the local storage of the tamperproof mobile device (e.g. Padloc) (330). The device holds the credential information in an encrypted data file (340). When a request is made by the user to back up credentials remotely, the user enters in a PIN (350) and the data is encrypted using DUKPT (360). The encrypted data is then stored in a Hardware Security Module (HSM) or a database protected by HSM (370). When the tamperproof mobile device (e.g. Padloc) needs to be re-provisioned, it is done so using DUKPT with the user-provided PIN. (380).

Finally, an incentive system is disclosed that reward distributors by giving them a percentage of the annual fees paid by the users they subscribe for the back-up service.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

Thus, specific compositions and methods of providing a secure remote backup and recovery service have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed:

1. A system for securely backing up and remotely storing an encrypted data file contained in a dedicated tamperproof module within a mobile device comprising:
a dedicated tamperproof module within a mobile device for holding identification and credential information personal to a user in an encrypted data file, said device optionally directly connected to another network device running an e-wallet application;
a means for a user to request the remote backup of said encrypted data file and to provide a PIN;
a means for said encrypted data file to be locked using said PIN using DUKPT or the like;
a means for transmitting said locked encrypted data file to a Distributed Registration and Access Control System used to identify a server and location for secure storage of said locked encrypted data file within a Hardware Security Module (HSM) infrastructure.

2. A system for securely retrieving and re-provisioning a locked encrypted data file onto a dedicated tamperproof module within a mobile device comprising:
a dedicated tamperproof module within a mobile device for holding identification and credential information in an encrypted data file, said device optionally directly connected to a network device running an e-wallet application;
a means for a user to request the re-provisioning of data on said device and to provide a PIN;
a means for transmitting said request to a Distributed Registration and Access Control System used to identify a server and location for secure storage of a locked encrypted data file associated with the user within a Hardware Security Module (HSM) infrastructure a means for verifying the user using said PIN;
a means for transmitting said locked encrypted data file back to said tamperproof mobile device, and
a means for re-provisioning said dedicated tamperproof module within a mobile device using said encrypted data file and said PIN to unlock said locked encrypted data file.

3. A system as in claim 2 further comprising:
a means for verifying the user using out-of-band authentication technology.

4. A method for securely backing up an encrypted data file contained in a dedicated tamperproof module within a mobile device comprising the steps of:
requesting a backup of said encrypted data file and providing a PIN;
locking said encrypted data file with the PIN using DUKPT or the like to create a locked encrypted data file transmitting said locked encrypted data file over the network to a Distributed Registration and Access Control System that is secured within an Hardware Security Module (HSM) infrastructure;
storing said encrypted data file on a server determined by said Distributed Registration and Access Control System that is secured within a Hardware Security Module (HSM) infrastructure;

5. A method for securely retrieving and re-provisioning a locked encrypted data file onto a dedicated tamperproof module within a mobile device comprising the steps of:
creating a request to retrieve a locked encrypted data file and providing a PIN;
transmitting said request over the network to a Distributed Registration and Access Control System used to identify a server and location for secure storage of said locked encrypted data file within a Hardware Security Module (HSM) infrastructure.
verifying the user's identity using said PIN;
transmitting said encrypted data file to a dedicated tamperproof module within a mobile device;
re-provisioning said dedicated tamperproof module within a mobile device using the encrypted data file and said PIN used to lock said encrypted data file.

6. A method as in claim 5 further comprising the steps of:
verifying the user using out-of-band authentication technology.

7. A method of rewarding Distributed Registration and Access Control System operators comprising the steps of:
providing operators a percentage of the annual fees paid by users who subscribe for the identification and credential back-up service.
